(19) United States
(12) Patent Application Publication
(10) Pub. No.: US 2021/0319964 A1
(43) Pub. Date: Oct. 14, 2021

(54) PUSH SWITCH WITH LED LIGHT

(71) Applicant: Ching-Hsiung CHU, New Taipei City (TW)

(72) Inventor: Ching-Hsiung CHU, New Taipei City (TW)

(21) Appl. No.: 16/847,677

(22) Filed: Apr. 14, 2020

(51) Int. Cl. H01H 13/10; F21V 8/00; H01H 13/02; H01H 13/14

(52) U.S. Cl. CPC H01H 13/10; G02B 6/0073; H01H 2219/062; H01H 13/14; H01H 2227/036; H01H 13/023

(57) ABSTRACT

The present invention provides a push switch with LED light. The push switch with LED light includes a substrate provided with a plurality of conductive elements; at least one LED lamp disposed on an upper side of the substrate; a conductive elastic sheet disposed on the substrate; and a pressing upper cover correspondingly covered and fixed on the substrate, wherein a pressing portion is provided at a center of the pressing upper cover, a pressing block extending downward is provided below the pressing portion, the pressing portion can be moved downward under pressure so that the pressing block presses the conductive elastic sheet, when the conductive elastic sheet contacts the conductive elements, they are turned on to drive the LED lamp to emit light. By replacing metal wires with characteristics of extremely thin printed circuits, it is possible to create unprecedented thinness in the use of space.

### FIELD OF INVENTION

The present invention relates to a push switch with LED light, and in particular, to a thin structure to make small size switches with LEDs.

### BACKGROUND OF INVENTION

On a variety of electronic products, it is often seen that control buttons are used to generate signals to activate and control functions. However, there are many specifications, sizes, and types of switches, and application ranges of the switches are quite wide.

On some precision equipment, due to limitations of available space, it will need to be applied to switches with light having a very small size. For example, an overall thickness is only about a few mm, or even a switch with LED light having a size smaller than 3 mm will be needed.

In the technical field of the switches with light having small size, because the design of each institution has been very streamlined and well-established for years, it is not easy for a designer to achieve further streamlining and thinning through any structural change. It can be seen that there is a technical bottleneck in the prior art.

In this type of extremely small switch with light, we know that it is installed on a housing of an LED light. In order to ensure that a thickness of a metal wire of a power line does not affect an overall thickness, the metal wire is buried in a plastic outer housing, so as to ensure that a thickness of the metal wire does not increase the overall thickness. Therefore, it can be seen that a size that an integrated thickness of the outer housing and the metal wire can reach is limit of the technology.

In addition, for the above technology, not only the thickness is limited, if users expect to use a plurality of LED light sources, it will be difficult to make because of increase of the metal wires. This is a main technical bottleneck in an application of technologies. Furthermore, in conventional switches, it is necessary to connect to the outside through transmission pins. This part is difficult to simplify, and it is also a problem that cannot easily reduce space requirements.

Therefore, in view of the foregoing, an inventor of the present invention contemplates and designs a push switch with LED light, in order to improve a lack of current technologies, thereby enhancing an industrial implementation.

### TECHNICAL SOLUTION

In view of aforesaid shortcomings of the prior art, the present invention is to design a push switch with LED light with patent elements such as novelty, inventive step, and industrial applicability, in order to overcome difficulties of the prior art.

In order to achieve the above objective, technical means adopted in the present invention is to design a push switch with LED light. The push switch with LED light comprises a substrate provided with a plurality of conductive elements thereon, wherein the plurality of conductive elements exposes an upper surface of the substrate and are separated with each other at a non-conductive state, and wherein the substrate is a printed circuit board, and the conductive element is a printed circuit on a surface of the substrate; at least one LED lamp correspondingly disposed on an upper side of the substrate and is electrically connected to one of the conductive elements; a conductive elastic sheet disposed on the substrate, wherein the conductive elastic sheet is a sheet material with elasticity and arc shape, and wherein the conductive elastic sheet corresponds to the non-conductive components, and a bottom wall of the conductive elastic sheet comprises conductive characteristics; and a pressing upper cover correspondingly covered and fixed on the substrate, wherein a pressing portion is provided at a center of the pressing upper cover, a pressing block extending downward is provided below the pressing portion, the pressing portion can be moved downward under pressure so that the pressing block presses the conductive elastic sheet, when the conductive elastic sheet contacts the conductive elements, the conductive elastic sheet and the conductive elements are turned on to drive the at least one LED lamp to emit light.

Wherein, the at least one LED lamp is arranged in a horizontal direction, and a refractive plate is disposed in front of the at least one LED lamp, which is made of a material with light guiding characteristics.

Wherein, a thickness of the substrate ranges from 0.3 mm to 1 mm.

Wherein, a bottom of the substrate is provided with a welding portion.

Wherein, a height from an upper surface of the pressing portion to a bottom wall surface of the substrate ranges from 1.5 mm to 2 mm.

Wherein, a light transmitting portion is provided on the pressing portion.

The design of the push switch with LED light of the present invention is mainly through a subversive design, and further, the printed circuit board is used as a carrier for the LED lamp. By replacing the metal wires with the characteristics of extremely thin printed circuits, it is possible to create a very thin thickness in the use of space, thereby improving the conventional technology that it is impossible to place a plurality of LED lamps on a switch with light that is minimized to a thickness of 2 mm or less, for example. In addition, the bottom of the substrate is fixed and conductive through welding, which can save the space required by conventional technology to use pins for transmission, and can further achieve a purpose of thinning, which is beyond the reach of the current technology.

### DESCRIPTION OF DRAWINGS

FIG. 1 is a schematic view of a push switch with LED light according to the present invention.

FIG. 2 is a partially exploded schematic view of the push switch with LED light according to the present invention.

FIG. 3 is an exploded view of the push switch with LED light according to the present invention.

FIG. 4 is an exploded view of another aspect of the push switch with LED light according to the present invention.

FIG. 5 is a sectional view of the push switch with LED light according to the present invention.

### DETAILED DESCRIPTION OF PREFERRED EMBODIMENTS

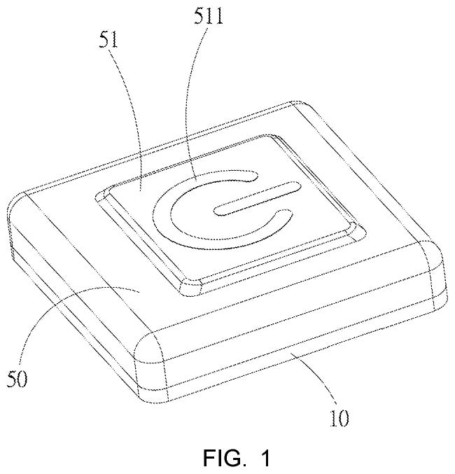

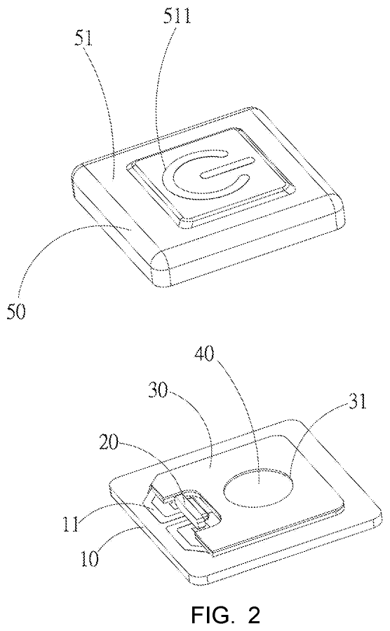

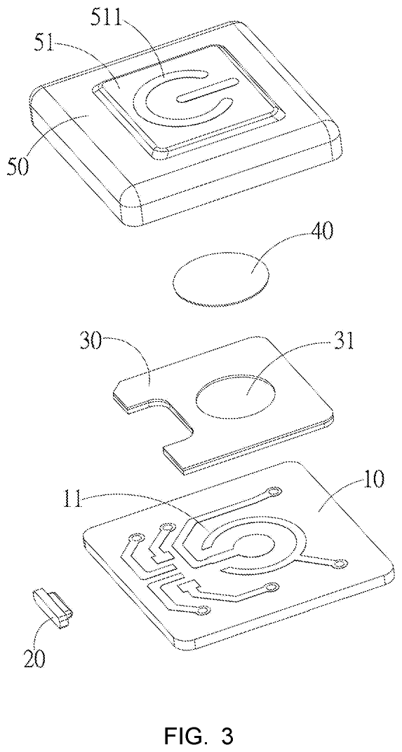

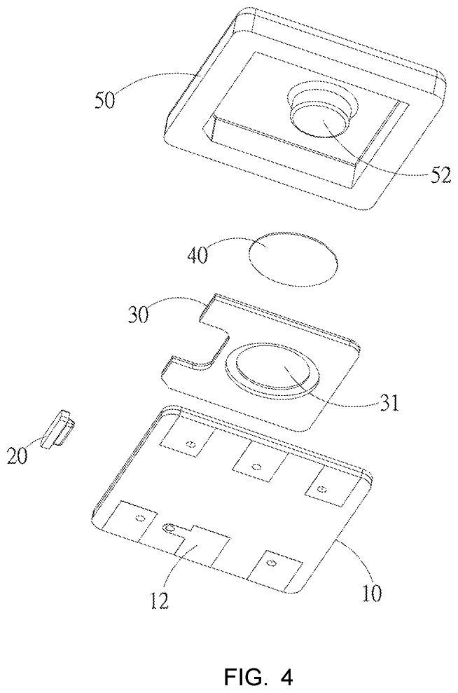

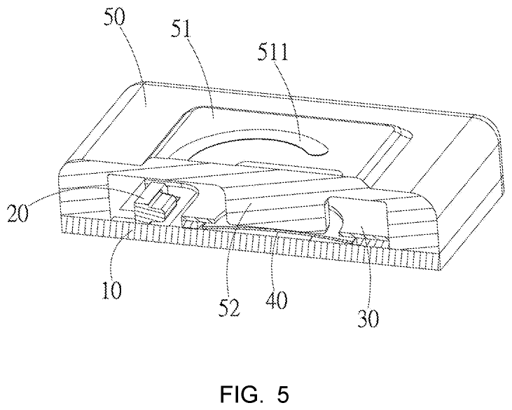

Please refer to FIG. 1 to FIG. 5. The present invention relates to a push switch with LED light. The push switch with LED light comprises a substrate 10, at least one LED lamp 20, a refractive plate 30, a conductive elastic sheet 40, and a pressing upper cover 50.

The substrate 10 is provided with a plurality of conductive elements 11 thereon. The plurality of conductive elements 11 exposes an upper surface of the substrate 10 and are separated with each other at a non-conductive state. The substrate 10 is a printed circuit board, and the conductive element 11 is a printed circuit on a surface of the substrate 10. A thickness of the substrate 10 ranges from 0.3 mm to 1 mm. In addition, a bottom of the substrate 10 is provided with a welding portion 12, which can be fixed and conducted by welding. The LED lamp 20 is correspondingly disposed on an upper side of the substrate 10 and is electrically connected to the conductive elements 11. The LED lamp 20 may be arranged horizontally, so as to illuminate light in a horizontal direction.

The mentioned conductive elastic sheet 40 is correspondingly provided in a via hole 31 of the refractive plate 30 and is disposed on the substrate 10. The conductive elastic sheet 40 is a sheet material with elasticity and arc shape, wherein the conductive elastic sheet 40 corresponds to the non-conductive components 11, and a bottom wall of the conductive elastic sheet 40 comprises conductive characteristics.

The pressing upper cover 50 is correspondingly covered and fixed on the substrate 10. A pressing portion 51 is provided at a center of the pressing upper cover 50, or a light transmitting portion 511 may be provided. A pressing block 52 extending downward is provided below the pressing portion 51, the pressing portion 51 can be moved downward under pressure so that the pressing block 52 presses the conductive elastic sheet 40. When the conductive elastic sheet 40 contacts the conductive elements 11, the conductive elastic sheet 40 and the conductive elements 11 are turned on to drive the LED lamp 20 to emit light. A height from an upper surface of the pressing portion 51 to a bottom wall surface of the substrate 10 ranges from 1.5 mm to 2 mm.

The push switch with LED light of the present invention is mainly through a subversive design. The printed circuit board is used as a carrier for the LED lamp 20. By replacing the metal wires with the characteristics of extremely thin printed circuits, it is possible to create a very thin thickness in the use of space, thereby improving the conventional technology that it is impossible to place a plurality of LED lamps on a switch with light that is minimized to a thickness of 2 mm or less, for example. In addition, the bottom of the substrate 10 is fixed and conductive through welding, which can save the space required by conventional technology to use pins for transmission, and can further achieve a purpose of thinning, which is beyond the reach of the current technology.

### REFERENCE NUMERALS

10: substrate
11: conductive element
12: welding portion
20: LED lamp
30: refractive plate
31: via hole
40: conductive elastic sheet
50: pressing upper cover
51: pressing portion
511: light transmitting portion
52: pressing block

1. A push switch with LED light, comprising:
a substrate provided with a plurality of conductive elements thereon, wherein the plurality of conductive elements exposes an upper surface of the substrate and are separated with each other at a non-conductive state, and wherein the substrate is a printed circuit board, and the conductive element is a printed circuit on a surface of the substrate;
at least one LED lamp correspondingly disposed on an upper side of the substrate and is electrically connected to one of the conductive elements;
a conductive elastic sheet disposed on the substrate, wherein the conductive elastic sheet is a sheet material with elasticity and arc shape, and wherein the conductive elastic sheet corresponds to non-conductive components, and a bottom wall of the conductive elastic sheet comprises conductive characteristics; and
a pressing upper cover correspondingly covered and fixed on the substrate, wherein a pressing portion is provided at a center of the pressing upper cover, a pressing block extending downward is provided below the pressing portion, the pressing portion can be moved downward under pressure so that the pressing block presses the conductive elastic sheet, when the conductive elastic sheet contacts the conductive elements, the conductive elastic sheet and the conductive elements are turned on to drive the LED lamp to emit light;
wherein the at least one LED lamp is arranged in a horizontal direction, a refractive plate is disposed in front of the at least one LED lamp and is disposed between the substrate and the conductive elastic sheet, and the refractive plate is made of a material with light guiding characteristics; and
wherein a thickness of the substrate ranges from 0.3 mm to 1 mm.

2. (canceled)

3. (canceled)

4. The push switch with LED light as claimed in claim 1, wherein a bottom of the substrate is provided with a welding portion.

5. The push switch with LED light in claim 1, wherein a height from an upper surface of the pressing portion to a bottom wall surface of the substrate ranges from 1.5 mm to 2 mm.

6. The push switch with LED light as claimed in claim 1, wherein a light transmitting portion is provided on the pressing portion.
